(19) United States
(12) Patent Application Publication
(10) Pub. No.: US 2009/0053486 A1
(43) Pub. Date: Feb. 26, 2009

(54) WEAR AND CORROSION RESISTANT COATING

(75) Inventors: Elizabeth P. Cooke, Lyme, NH (US); Ryan D. Evans, Jackson Township, OH (US); Gary L. Doll, Jackson Township, OH (US); Randy P. Kruse, North Canton, OH (US); Carl R. Ribaudo, Jackson Township, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 12/281,867

(22) PCT Filed: Mar. 23, 2007
(86) PCT No.: PCT/US07/64774

§ 371 Date: Sep. 5, 2008

Related U.S. Application Data
(60) Provisional application No. 60/785,298, filed on Mar. 23, 2006.

(51) Int. Cl. B32B 15/08; B05D 1/36; B32B 15/04

(52) U.S. Cl. 428/209; 427/264; 427/402; 427/419.7; 427/409

(57) ABSTRACT

A method for treating a substrate (such as the gears of a gear set) to provide the substrate with both wear protection and corrosion resistance is disclosed. The method comprises providing the substrate with a wear protection layer and providing corrosion resistant layer. The wear protection layer can be applied to the gear and then the corrosion resistant layer can be applied over the wear resistant layer. Alternatively, the corrosion resistant lay can be provided and then the wear resistant layer can be formed over the corrosion resistant layer.

### CROSS REFERENCE TO RELATED APPLICATIONS

This application is claims priority to U.S. patent application 60/785,298 filed Mar. 23, 2006, which is incorporated herein by reference.

### STATEMENT REGARDING FEDERALLY SPONSORED RESEARCH OR DEVELOPMENT

This invention relates generally to surface treatments for gears, and, in particular, to corrosion and wear resistant surface treatments for gears (and especially spiral bevel gear sets).

### BACKGROUND OF THE INVENTION

Gear sets are commonly employed to transmit power. The gears of a gear set are often made from steel, which can be a hardened steel. The gear sets can be subject to physical conditions (oil-out conditions, grit, etc.) which adversely affect the operating life of the gear. Gear sets can also be subject to corrosive conditions, which again, can adversely affect the operating life of the gear.

The current state of the art in providing corrosion resistance to steel alloy components is to provide a thick (i.e., 20 μm or greater) coating of Cr or Ni alloys. (Thinner coatings (i.e., <3 μm) of Cr or Ni alloys provide corrosion resistance in ASTM B117 salt spray for less than 24 hours.) This procedure works extremely well to provide corrosion resistance. However, the coating is so thick that it changes the dimensions of the component, thereby requiring a component redesign. Further, these thick coatings do not wear atomically under high loads and sliding speeds, but through fracture and delamination, making them unsuitable as wear resistant coatings.

The current state of the art in providing wear resistance to steel alloy components is to provide MC/aC:H (nanocrystalline metal carbide/amorphous hydrocarbon composite) or chromium nitride coatings. These coatings, however, whether applied via PVD or CVD, have numerous pin holes extending through the coating to the substrate. The reason for pin hole formation during the deposition of the coating is not well understood, but pin holes are an inherent feature of PVD and CVD coatings on steel alloy substrates. The presence of the pin holes in the coating can lead to galvanic corrosion—which can accelerate the corrosion of the steel alloy substrate beyond its uncoated state.

### BRIEF SUMMARY OF THE INVENTION

Briefly stated, this invention describes a duplex or dual-component coating which provides both wear resistance and corrosion resistance to steel alloy components, such as beveled gears. The dual-component coating comprises either (a) a thin (i.e., less than about 3 μm) layer of Ni or a Ni alloy applied to the steel alloy substrate and a thin (i.e., less than about 3 μm) chromium nitride or MC/aC:H is applied on top of the Ni or Ni alloy coating; or (b) a thin (i.e., less than about 3 μm) layer of chromium nitride or MC/aC:H applied to the steel alloy substrate and a thin (i.e., less than about 3 μm) of Ni or Ni alloy is applied over the coating of chromium nitride or MC/aC:H. In the first, the corrosion resistant layer is applied to the substrate and the wear layer is applied over the corrosion resistant layer. In the second, the wear layer is applied to the substrate and the corrosion resistant layer is applied over the wear layer.

A method for treating a substrate (such as the gears of a gear set) to provide the substrate with both wear protection and corrosion resistance is disclosed. The method comprises providing the substrate with both a wear protection layer and a corrosion resistant layer. The wear protection layer can be applied to the gear and then the corrosion resistant layer can be applied over the wear resistant layer. Alternatively, the corrosion resistant layer can be applied to the gear and then the wear resistant layer can be formed over the corrosion resistant layer.

### BRIEF DESCRIPTION OF THE SEVERAL VIEWS OF THE DRAWINGS

FIG. 1 is a perspective view of a spiral bevel gear set;

FIG. 2 is a diagrammatic sketch of a dual-component wear resistant/corrosion resistant coating treatment of the present invention.

FIG. 3 includes photographs showing the effectiveness of the corrosion resistant layer; and

FIG. 4 includes photographs of a coupon coated with a wear resistant layer and an uncoated coupon to demonstrate the lack of corrosion resistance provided by the wear resistant layer.

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

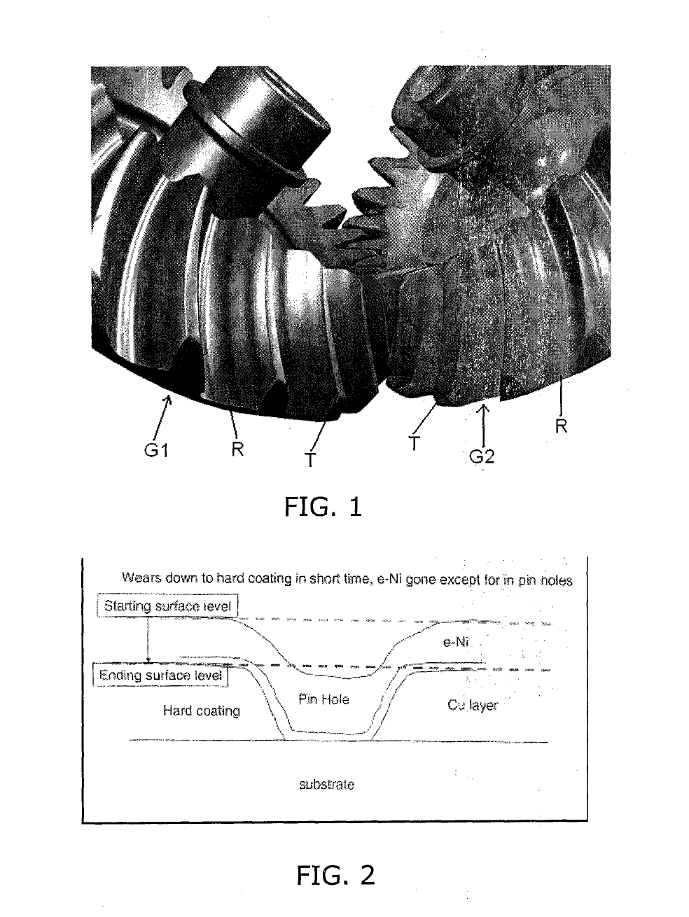

With reference to FIG. 1, a gear set, as is known, includes a pair of gears G1 and G2, each of which includes teeth T and roots R between the teeth. As is known, the teeth of the gear pair mesh with each other, such that a drive gear causes rotation of a driven gear. The gear set shown in FIG. 1 comprises a spiral bevel gear set. As seen, the top edges of the teeth are formed on a bevel (that is, in plan view the gear defines a trapezoid). Additionally, the teeth T are spiraled, rather than straight. Although the invention is shown for use on a spiral bevel gear set, it will be appreciated that the treatment process is applicable for other gears, and in fact, for other types of substrates (i.e., bearings, etc.)

To provide both wear protection and corrosion resistance to the gears, in one illustrative example, a wear layer can be formed on the gear and a corrosion resistant layer can then be formed over the wear layer to provide corrosion resistance.

The wear layer can, for example be (1) a composite coating containing nanocrystalline metal-carbides and an amorphous hydrocarbon matrix (i.e., MC/aC:H) (such as Timken's ES300 coating); (2) a two layered system comprised of a MC/aC:H and an non-metal containing (or metal-free) amorphous hydrocarbon (aC:H); (3) a two layered system comprised of a chromium nitride and an amorphous hydrocarbon (aC:H); (4) a single layer of aC:H that may also contain Si, (4) B₄C or B₄C and metals (such as Ti, W, Ta, or Cr); (5) a metal nitride (such as a titanium nitride or chromium nitride) coating; or (6) a metal carbide (such as titanium carbide). The wear layer is preferably about 3 μm or less in thickness.

The corrosion resistant layer can be a surface treatment of either the gear itself or on the wear coating. Alternatively, the corrosion resistant layer can be under a wear coating (i.e., the corrosion resistant layer is applied t the gear and the wear coating is applied over the corrosion resistant layer). Examples of surface treatments that can provide corrosion resistance include ion implantation of nitrogen, chromium, or other metals (such as nickel). Ion implantation can be performed via plasma nitriding, plasma immersion ion implantation (PIII), or classical ion implantation procedures. If the corrosion resistant layer is to be a coating, the coating can be, for example, nickel or nickel alloys such as nickel-cobalt (NiCo), nickel boron (NiB), or nickel phosphorous (NiP) compounds applied using electrolytic or electroless (autocatalytic) processes. A nickel-zinc (NiZn) alloy (such as disclosed in U.S. Pat. No. 5,352,046 which is incorporated herein by reference, and which is available from The Timken Company under the name of AquaSpexx®) can also be used. Metals such as tantalum (Ta), chromium (Cr), aluminum (Al), niobium (Nb), or titanium (Ti) which can be anodized to form oxide phases can also be used. Additionally, epoxies, petroleum distillates, PMMA (poly(methyl methacrylate)), common lubricant additives, rare earth elements, or sealants (such as Loctite® available from Henkel Loctite® or WD40®) may also work to provide corrosion resistance. Hypophosphates (HyPO₄) may also work. Further, chemical conversion layers can be applied either to the gear substrate or over the wear layer. Chromium ion implantation can be performed on wear resistant coatings such as MC/aC:H or chromium nitride to provide corrosion resistance to the steel alloy regions exposed by the pin holes in the coating.

The advantage of surface treatments (such as ion implantation by PIII, PVD, CVD, etc.) is that the surface geometry of the gear is not modified. This can be important, for example, in gear sets, where tolerances must be closely monitored and maintained. If a coating is used, the coating will preferably be about 5 μm or less.

In one illustrative example, the gears can be plated with electroless nickel to provide corrosion resistance. A MC/aC:H (such as WC/aC:H) wear coating can then be applied over the electroless nickel layer. In this instance, the outer layer will provide the wear resistance and the inner layer will provide the corrosion resistance. Although the outer wear layer may have pin holes, the corrosion resistant layer which is between the wear layer and the gear (i.e., substrate) will prevent corrosive elements from reaching the gear substrate and corroding the gear. Currently at least a 20 μm thick coating of electroless Ni is required to provide significant corrosion resistance as indicated by 48 hours to first visual evidence of corrosion in an ASTM B117 salt spray test. This is too thick for most applications and does not wear well. Additionally, as noted above, it fractures under loads. Our dual-component coating requires only a very thin (i.e., less than about 3 μm) layer of Ni since it will be covered with the MC/aC:H coating and only needs to be present in the vicinity of the pin holes in the MC/aC:H coating.

In a second illustrative example, a wear layer can be applied to the gear (i.e. substrate), and then a corrosion resistant (or sealant) layer can be applied over the wear layer. In this example, the wear layer can be a chromium nitride or a MC/aC:H or an aC:H layer and the corrosion resistant layer can be electroless nickel. Alternatively, the wear layer can include both the MC/aC:H and the aC:H components. In this variation, a metal free amorphous hydrocarbon (aC:H) would be applied over the nanocrystalline metal carbide/amorphous hydrocarbon composite layer (MC/aC:H). In this example, the sealant (corrosion resistant) layer can effectively be a sacrificial layer. When the sealant (corrosion resistant) layer is applied over the wear layer, the sealant (corrosion resistant) will fill the pin holes, as seen in FIG. 2. Because the sealant layer may not be a wear resistant layer, the sealant layer may be worn down to the level of the wear resistant layer. However, the sealant which fills the pin holes will remain in the pin holes, thereby blocking or closing the pin holes. With the pin holes blocked or closed by the sealant, corrosive elements will not be able to penetrate the wear layer, thereby affording corrosion resistance to the steel alloy substrate. With a sacrificial corrosion resistant layer, the sacrificial layer can be removed by running the gear against a dummy or soft opposing part to insure that the corrosion resistant layer is embedded (or fills) any pin holes in the wear coating. In this example, once the corrosion resistant layer is worn away, the dual-component coating will have a thickness that is approximately equal to the thickness of the wear resistant layer. Yet, the dual-component coating will provide both wear resistance and corrosion resistance.

In a third example, the gear can be coated with a chromium nitride layer which is transitioned to a Cr coating (for example, deposited by PVD processes). The outer Cr layer of the coating can then be anodized to form a Cr oxide layer. For reasons not yet understood, anodization of a coating like Cr (which contains pin holes), appears to be sufficient to provide an enhanced degree of corrosion resistance over a pure Cr layer with pin holes.

In another example, a corrosion resistant layer can be formed on the gear via PIII of Cr ions into the steel alloy surface, and a wear layer of a nanocomposite metal carbide/ amorphous hydrocarbon composite, a Si-containing amorphous hydrocarbon, and/or a metal free amorphous hydrocarbon, or Chromium nitride can be applied over treated gear surface.

In another example, an electroless-nickel layer can be applied to the gear surface and then a wear coating can be applied over the nickel layer. However, prior to applying the wear coating, the nickel layer can be bombarded with Cr, Ni or Ar ions to increase the density of the layer, and achieve a more uniform coverage of the steel alloy surface.

The method, as outlined above, proposes two methods for providing both corrosion resistance and wear protection to a steel alloy substrate (such as a steel alloy gear). In the first system, the corrosion resistant layer is beneath the wear layer. Here, the corrosion resistance layer can include a thin (i.e., less than about 3 μm) layer of Ni applied via a solution-based process or Cr implantation applied via ion implantation or PIII. The wear resistant layer can comprise: (1) a thin (i.e., less than about 3 μm) layer of MC/aC:H applied, for example, via reactive magnetron sputtering; (2) a thin (i.e., less than about 3 μm) layer of Chromium nitride applied, for example, via reactive magnetron sputtering; (3) a thin (i.e., less than about 3 μm) layer of Si-aC:H applied, for example, via plasma enhanced CVD; (4) a thin (i.e., less than about 3 μm) bi-layer of MC/aC:H and aC:H applied, for example, via reactive magnetron sputtering and CVD; or (5) a thin (i.e., less than about 3 μm) layer of B₄C applied, for example, via magnetron sputtering.

In the second method, the wear resistance layer underlies the corrosion resistance layer. Here, the corrosion resistance layer acts as a sealant, filling the pinholes or cracks in the wear resistant layer. In this method, the wear resistant layer can be the same as just noted above. The corrosion resistant layer can comprise electroless Ni, epoxy resins, lubricant additives, polymer sealants, and AquaSpexx®.

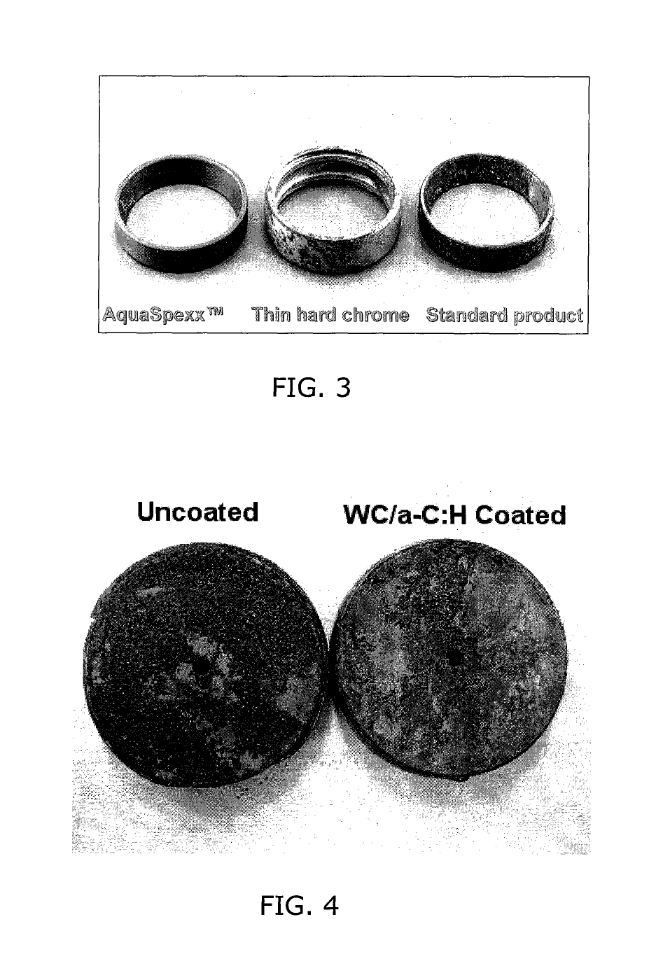

FIG. 3 shows three rings, one coated with a NiZn, on coated with hard chrome, and one uncoated. AquaSpexx®, which is available from The Timken Company, was used for the NiZn coating. FIG. 3 illustrates the effectiveness of the Ni-based corrosion resistant coating as compared to the chrome plating or uncoated cases. After 24 hrs of ASTM B117 salt spray corrosion testing, no rust was present on the AquaSpexx-coated ring (the AquaSpexx coating has a natural “rainbow” green-yellow hue appearance), while red rust is clearly observed on the chrome-coated and standard rings.

In FIG. 4 shows the effect of salt-spray corrosion testing on a steel-alloy coupon coated with a WC/a-C:H coating and an uncoated coupon The WC/a-C:H coating used was ES300, available from The Timken Company. As seen in FIG. 4, the ES300 coated coupon and the uncoated coupon both had a significant amount of rusting. The images of FIG. 4 demonstrate that the wear resistant layer does not protect the alloy against corrosion. That is, the wear resistant layer is not a corrosion resistant layer. The corrosion resistance is supplied by the second component of the coating—the Ni layer which will form a layer over the substrate (either on top of, or beneath the wear resistant layer) which is much more impervious the corrosion. As noted above, if the corrosion resistant layer is applied over the wear resistant layer, the coating resistant layer can be worn down, such that the over-all coating has a thickness substantially equal to the thickness of the wear resistant layer. Yet, the pin holes in the wear resistant layer will be filled, blocked, or plugged by the corrosion resistant nickel.

As various changes could be made in the above constructions without departing from the scope of the invention, it is intended that all matter contained in the above description or shown in the accompanying drawings shall be interpreted as illustrative and not in a limiting sense.

1. A method for providing both wear protection and corrosion resistance to a metallic substrate, the method comprising:
depositing a thin film wear protection layer on the substrate; the wear protection layer being deposited by a method that will leave imperfections in the wear protection layer which can be penetrated by corrosive elements; and
depositing a corrosion resistant layer over the wear protection layer; the material of the corrosion resistant layer filling the imperfections in the wear protection layer to prevent corrosive elements from reaching the substrate.

2. The method of claim 1 wherein the method of depositing the thin film wear protection layer comprises applying the protection layer such that the protection layer has a thickness of less than about 3 micrometers.

3. The method of claim 1 wherein the corrosion resistant layer is a sacrificial layer, the method further comprising a step of wearing down the corrosion resistant layer thereby removing the corrosion resistant layer from the wear layer, except for where the corrosion resistant layer fills the imperfections.

4. The method of claim 1 wherein the wear layer comprises a coating chosen from the group consisting of nanocrystalline metal carbide/amorphous hydrocarbon composites, metal-free amorphous hydrocarbon, silicon- containing amorphous hydrocarbon, boron carbides, metal nitrides, and combinations thereof.

5. The method of claim 1 wherein the corrosion resistant layer comprises polymers, anodized metals, lubricant additive films and their derivatives and combinations thereof.

6. The method of claim 1 wherein the corrosion resistant layer comprises nickel alloys containing P, B, Co, W, Th, Zn and combinations thereof.

7. A gear having a metallic surface, the improvement comprising a wear layer on said gear surface and a corrosive resistant material; said wear layer being less than about 3 micrometers and having imperfections therein through which corrosive elements could pass; said corrosive resistant material filling the imperfections the wear protective layer to substantially prevent corrosive materials from reaching the gear surface.

8. The gear of claim 7 wherein the corrosion resistant material is applied over said wear protection layer as a sacrificial layer and is worn down until it is substantially removed, whereby that the corrosion resistant material fills the imperfections of the wear protection layer.

9. The gear of claim 7 wherein the wear layer comprises a coating chosen from the group consisting of nanocrystalline metal carbide/amorphous hydrocarbon composites, metal-free amorphous hydrocarbon, silicon- containing amorphous hydrocarbon, boron carbides, metal nitrides, and combinations thereof.

10. The gear of claim 7 wherein the corrosion resistant material comprises polymers, anodized metals, lubricant additive films and their derivatives and combinations thereof.

11. The gear of claim 7 wherein the corrosion resistant material comprises nickel alloys containing P, B, Co, W, Th, Zn and combinations thereof.

12. The gear of claim 10 wherein the polymers are PMMA or PTFE.

13. The gear of claim 10 wherein the derivatives of the corrosion resistant material comprise chemical conversion layers.
